(19) United States
(12) Patent Application Publication
(10) Pub. No.: US 2017/0307122 A1
(43) Pub. Date: Oct. 26, 2017

(54) SLIDE VALVE, FEMALE COUPLING MEMBER HAVING THE SLIDE VALVE, AND PIPE COUPLING COMPRISING THE FEMALE COUPLING MEMBER AND MALE COUPLING MEMBER

(71) Applicant: NITTO KOHKI CO., LTD., Tokyo (JP)

(72) Inventor: Yuki IMOTO, Tokyo (JP)

(21) Appl. No.: 15/645,185

(22) Filed: Jul. 10, 2017

Related U.S. Application Data
(63) Continuation of application No. PCT/JP2016/068707, filed on Jun. 23, 2016.

(30) Foreign Application Priority Data
Jun. 26, 2015 (JP) 2015-128221

(51) Int. Cl. F16L 37/32; F16L 37/22

(52) U.S. Cl. CPC F16L 37/32; F16L 37/22

(57) ABSTRACT

A slide valve set in a fluid passage and displaceable in a direction of a longitudinal axis of the fluid passage to open or close the fluid passage, the slide valve being simplified in structure and having a plurality of seal portions. The slide valve includes a cylindrical slide valve body set coaxially with the fluid passage, the slide valve body having an outer peripheral surface, an inner peripheral surface, and at least one through-hole extending through from the outer peripheral surface to the inner peripheral surface. The slide valve further includes a seal member having an annular outer seal portion located over the outer peripheral surface of the slide valve body, an annular inner seal portion located over the inner peripheral surface of the slide valve body, and a connecting portion located in the through-hole to connect together the outer seal portion and the inner seal portion.

### TECHNICAL FIELD

The present invention relates to a slide valve used in a coupling member, a female coupling member having the slide valve, and a pipe coupling comprising the female coupling member and a male coupling member.

### BACKGROUND ART

Pipe couplings comprising a female coupling member and a male coupling member, which are coupled together, include one that has a valve mechanism for preventing leakage of the inner fluid when the female and male coupling members are decoupled and separated from each other. A female coupling member of a pipe coupling having such a valve mechanism is usually configured to have a cylindrical female coupling body and a valve seat part provided in a fluid passage defined by the inner surface of the female coupling body at a position spaced radially inward from the inner surface to define an annular valve opening between the valve seat part and the inner surface. The female coupling member further has a slide valve disposed in the fluid passage and displaceable in the direction of a longitudinal axis of the fluid passage between a close position where the slide valve closes the valve opening and an open position where the slide valve opens the valve opening. When the female coupling member is in an uncoupled state where the female coupling member is not coupled to the associated male coupling member, the slide valve closes the valve opening to prevent the fluid in the fluid passage from leaking to the outside. When the male coupling member is inserted into the female coupling member, the slide valve is pushed into the open position by the male coupling member to open the valve opening. Consequently, the fluid passage in the female coupling member and the fluid passage in the male coupling member are communicated with each other, and the female coupling member and the male coupling member are connected together in a sealed state (Patent Literature 1 and Patent Literature 2).

### CITATION LIST

### Patent Literature

Patent Literature 1: Japanese Patent No. 5394460

Patent Literature 2: Japanese Patent Application Publication No. 2008-128285

### SUMMARY OF INVENTION

### Technical Problem

For the above-described purpose, in the female coupling member of Patent Literature 1, for example, the slide valve is provided with a seal member sealingly and slidingly engageable with the inner surface of the female coupling member and a seal member sealingly engageable with a distal end portion of the male coupling member, and the outer peripheral surface of the valve seat part is provided with a seal member sealingly engageable with the inner peripheral surface of the slide valve. In the female coupling member of Patent Literature 2, the slide valve is provided with a seal member sealingly engageable with the inner surface of the female coupling member and a seal member sealingly engageable with the valve seat part, and the inner surface of the female coupling member is provided with a seal member sealingly engageable with the outer peripheral surface of the male coupling member. Thus, the female coupling member of a pipe coupling having the above-described valve function, usually, needs three seal members in relation to the valve function.

To provide the seal members, however, grooves or the like are needed to retain the seal members, respectively; therefore, the slide valve, female coupling body and other members unavoidably become complicated in configuration. The seal members can be provided on the slide valve and other members by injection molding, but a mold having a complicated structure is needed to mold a plurality of seal members. In addition, a large number of gates are required for the molding process, and it is often difficult to design so that the gates are positioned somewhere other than seal surfaces for sealing engagement with other members.

An object of the present invention is to solve the above-described problems with the conventional technique.

### Solution to Problem

The present invention provides a slide valve to be set in a fluid passage and displaceable in the direction of a longitudinal axis of the fluid passage to open or close the fluid passage. The slide valve includes a cylindrical slide valve body to be set coaxially with the fluid passage. The slide valve body has an outer peripheral surface, an inner peripheral surface, and at least one through-hole extending through from the outer peripheral surface to the inner peripheral surface. The slide valve further includes a seal member having an annular outer seal portion located over the outer peripheral surface of the slide valve body, an annular inner seal portion located over the inner peripheral surface of the slide valve body, and a connecting portion located in the through-hole to connect together the outer seal portion and the inner seal portion.

As has been stated above, the conventional slide valve needs to provide seal members individually to seal different areas at the radially outer and inner sides, respectively, of the slide valve. Accordingly, it is necessary to provide a groove or the like to secure each seal member to the slide valve body, which results in a complicated structure of the slide valve body and a complicated manufacturing process. In the slide valve according to the present invention, the slide valve body is provided with a single seal member having an outer seal portion and an inner seal portion which enable sealing of mutually different areas at the radially outer and inner sides of the slide valve and which are connected to each other by the connecting portion. Therefore, it is easy to attach the seal member to the slide valve body, and it is possible to simplify the structure of the slide valve body. The seal member can be formed by injection molding onto the slide valve body. In this regard, the number of process steps required in the present invention is smaller than the conventional slide valve in which a plurality of seal members are individually formed by injection molding. In addition, the mold gate can be easily positioned where no seal surface of the seal member will be formed.

Specifically, the slide valve may be configured to be disposed in the fluid passage of a female coupling member having a female coupling body having an inner surface defining the fluid passage. The female coupling member further has a valve seat part provided in the fluid passage at a position spaced radially inward from the inner surface of the female coupling body to define an annular valve opening between the valve seat part and the inner surface. The slide valve is displaceable between a close position where the slide valve closes the valve opening and an open position where the slide valve opens the valve opening at a position rearward of the close position in the direction of the longitudinal axis. When the slide valve is in the close position, the inner seal portion of the seal member sealingly engages the valve seat part.

The above is one form of the sealing function of the inner seal portion.

As another form of the sealing function of the inner seal portion, the slide valve may be configured to be disposed in the fluid passage of a female coupling member having a female coupling body having an inner surface defining the fluid passage. The female coupling member further has a valve seat part provided in the fluid passage at a position spaced radially inward from the inner surface of the female coupling body to define an annular valve opening between the valve seat part and the inner surface. The slide valve is displaceable between a close position where the slide valve closes the valve opening and an open position where the slide valve opens the valve opening at a position rearward of the close position in the direction of the longitudinal axis. The inner seal portion sealingly engages a distal end portion of a male coupling member as inserted into the female coupling member.

Further, the slide valve may be configured to be disposed in the fluid passage of a female coupling member having a female coupling body having an inner surface defining the fluid passage. The female coupling member further has a valve seat part provided in the fluid passage at a position spaced radially inward from the inner surface of the female coupling body to define an annular valve opening between the valve seat part and the inner surface. The slide valve is displaceable between a close position where the slide valve closes the valve opening and an open position where the slide valve opens the valve opening at a position rearward of the close position in the direction of the longitudinal axis. When the slide valve is in the close position, the outer seal portion of the seal member sealingly engages the inner surface of the female coupling body, and the inner seal portion sealingly engages the valve seat part. When the male coupling member is inserted into the female coupling member and the slide valve is brought into the open position, the outer seal portion of the seal member sealingly engages the inner surface of the female coupling body, and the inner seal portion sealingly engages the distal end portion of the male coupling member.

With the above-described structure, when the slide valve is in the close position and also in the open position, fluid leakage can be blocked by the single seal member of the slide valve, and it is possible to eliminate the need to provide seal members on the female coupling member and the valve seat part in addition to the slide valve as in the above-described conventional pipe coupling.

In the specific examples described above, the slide valve may be arranged such that when the slide valve is displaced between the close position and the open position, the outer seal portion slides along the inner surface of the female coupling body.

In addition, the inner seal portion may have an abuttingly-sealingly engaging surface abuttingly and sealingly engageable with a distal end surface of the distal end portion of the male coupling member, and an outer periphery sealingly engaging surface extending forward from the abuttingly-sealingly engaging surface to sealingly engage an outer peripheral surface of the distal end portion of the male coupling member.

The sealing function is ensured even more by both the abuttingly-sealingly engaging surface and the outer periphery sealingly engaging surface.

In addition, the slide valve may be arranged as follows. The slide valve body has a first cylindrical portion sliding along the inner surface of the female coupling member. The first cylindrical portion has an inner peripheral surface which is slidingly engaged with the male coupling member as inserted into the female coupling member. The slide valve body further has a second cylindrical portion contiguous with the first cylindrical portion and smaller in diameter than the first cylindrical portion. The through-hole is formed in the second cylindrical portion, and the outer seal portion is located over an outer peripheral surface of the second cylindrical portion.

With the structure in which the slide valve body has the first cylindrical portion having an inner surface which is slidingly engaged with the male coupling member as inserted into the female coupling member, it is possible to improve alignability of the male coupling member with respect to the seal member in the direction of the longitudinal axis.

The slide valve body may be made of a circular cylindrical member with a substantially uniform wall thickness. For example, the slide valve body may be formed by drawing a metal plate material. As has been stated above, in the slide valve according to the present invention, the seal member comprises the inner and outer seal portions, which are located at the radially inner and outer sides, respectively, of the slide valve body, and the connecting portion, which connects together the inner and outer seal portions. Thus, the slide valve needs no groove or the like for securing the seal member as required in the above-described conventional technique. Accordingly, the slide valve body can be made of a circular cylindrical member with a substantially uniform wall thickness.

Further, a specific example of the slide valve may be as follows. The slide valve body further has an abutment portion which is abutted by the distal end portion of the male coupling member as inserted into the female coupling member. The inner seal portion has a pliable annular portion extending forward in the direction of the longitudinal axis beyond the abutment portion and centered at the longitudinal axis. When the distal end portion of the male coupling member abuts against the abutment portion, the pliable annular portion is pressed and elastically deformed by the distal end surface of the male coupling member while sealingly engaging the distal end surface.

With the above-described pliable annular portion, even if a relative inclination occurs between the coupled female and male coupling members with respect to the longitudinal axis, the pliable annular portion is flexibly deformed in conformity with the inclination, thereby surely maintaining sealing between the inner seal portion of the seal member and the distal end surface of the male coupling member.

The above-described slide valve may be as follows. The slide valve body is made of a metal plate, and the seal member is made of rubber. The rubber seal member is vulcanized and bonded to the slide valve body at a portion thereof contacting the slide valve body.

With the above-described vulcanization bonding in addition to the connection between the outer and inner seal portions by the connecting portion, the seal member can be surely secured to the slide valve body.

In addition, the present invention provides a female coupling member having the above-described slide valve.

In addition, the present invention provides a pipe coupling comprising the above-described female coupling member, and a male coupling member configured to be coupled to the female coupling member by being inserted into the fluid passage in the female coupling member.

Embodiments of a slide valve, a female coupling member having the slide valve, and a pipe coupling comprising the female coupling member and a male coupling member according to the present invention will be explained below based on the accompanying drawings.

### BRIEF DESCRIPTION OF DRAWINGS

FIG. 1 is a sectional view of a pipe coupling according to a first embodiment of the present invention, showing the pipe coupling in an uncoupled state.

FIG. 2 is a sectional view of the pipe coupling in FIG. 1, showing the pipe coupling in the middle of being coupled.

FIG. 3 is a sectional view of the pipe coupling in FIG. 1, showing the pipe coupling in a coupled state.

FIG. 4 is a sectional view of a slide valve included in a female coupling member of the pipe coupling shown in FIG. 1.

FIG. 5 is a sectional view of a pipe coupling according to a second embodiment, showing the pipe coupling in an uncoupled state.

FIG. 6 is a sectional view of the pipe coupling in FIG. 5, showing the pipe coupling in the middle of being coupled.

FIG. 7 is a sectional view of the pipe coupling in FIG. 5, showing the pipe coupling in a coupled state.

FIG. 8 is a sectional view of a slide valve included in a female coupling member of the pipe coupling shown in FIG. 5.

### DESCRIPTION OF EMBODIMENTS

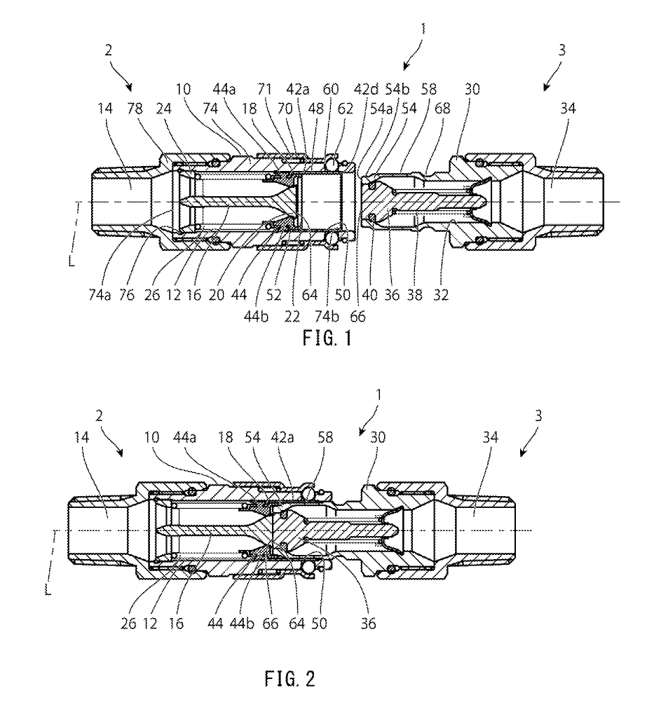

As shown in FIGS. 1 to 3, a pipe coupling 1 according to a first embodiment of the present invention comprises a female coupling member 2 and a male coupling member 3.

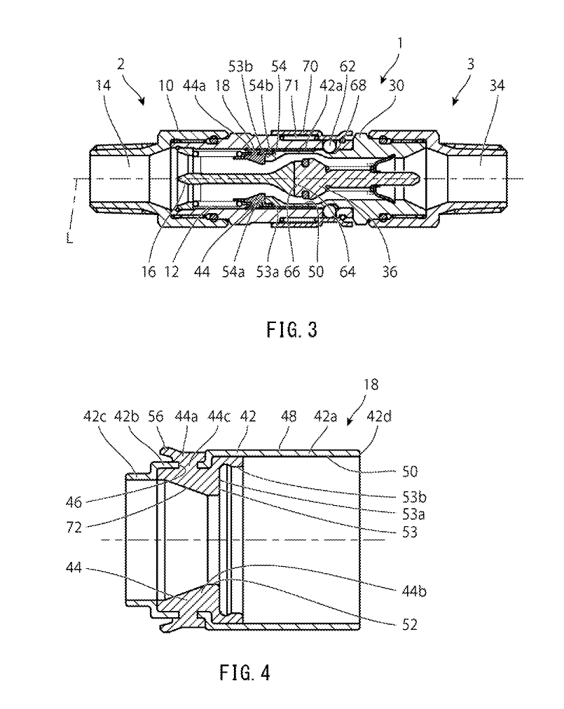

The female coupling member 2 has a cylindrical female coupling body 10, an elongated fixed valve seat member 16 disposed in a fluid passage 14 defined by an inner surface 12 of the female coupling body 10 such that the fixed valve seat member 16 extends along a longitudinal axis L of the fluid passage 14, and a slide valve 18 disposed in the fluid passage 14 displaceably in the direction of the longitudinal axis L. The fixed valve seat member 16 has an annular base part 24 connected to a rear end (left end as seen in the figures) thereof through circumferentially spaced radially extending connecting members (not shown). The fixed valve seat member 16 is secured to the inner surface 12 of the female coupling body 10 at the base part 24. Further, the fixed valve seat member 16 has an enlarged-diameter valve seat portion 20 at a front end (right end as seen in the figures) thereof. The valve seat portion 20 is located at a position spaced radially inwardly from the inner surface 12 to define an annular valve opening 22 between itself and the inner surface 12. The slide valve 18 is displaceable in the direction of the longitudinal axis L between a close position (FIG. 1) where the slide valve 18 closes the valve opening 22 and an open position (FIG. 3) where the slide valve 18 opens the valve opening 22. The slide valve 18 is urged forward (rightward as seen in the figures) toward the close position by a spring 26 set between the base part 24 of the fixed valve seat member 16 and the slide valve 18.

The male coupling member 3 has a cylindrical male coupling body 30, a slide valve 36 disposed in a fluid passage 34 defined by an inner surface 32 of the male coupling body 30 such that the slide valve 36 is displaceable in the direction of the longitudinal axis L, and a spring 38 urging the slide valve 36. An O-ring 40 is disposed on a distal end outer peripheral surface of the slide valve 36. When the slide valve 36 is in a close position (FIG. 1), the O-ring 40 seals between the slide valve 36 and the inner surface 32 to close the fluid passage 34.

The slide valve 18 of the female coupling member 2 comprises, as shown in FIG. 4, a slide valve body 42 and a single seal member 44 secured to the slide valve body 42. The slide valve body 42 is a circular cylindrical member having a substantially uniform wall thickness throughout and comprises a first cylindrical portion 42a having a size suitable for sliding engagement with the inner surface 12 of the female coupling body 10, a second cylindrical portion 42b contiguous with the first cylindrical portion 42a at the rear of the latter and smaller in diameter than the first cylindrical portion 42a, and a third cylindrical portion 42c contiguous with the second cylindrical portion 42b at the rear of the latter and smaller in diameter than the second cylindrical portion 42b. The second cylindrical portion 42b is formed with a plurality of circumferentially spaced through-holes 46. The third cylindrical portion 42c has a size suitable for being inserted into the coil spring 26 to retain the latter. The seal member 44 comprises an annular outer seal portion 44a located over a portion of an outer peripheral surface 48 of the slide valve body 42 which comprises the second cylindrical portion 42b, an annular inner seal portion 44b located over a portion of an inner peripheral surface 50 of the slide valve body 42 which comprises the second cylindrical portion 42b and the first cylindrical portion 42a, and a connecting portion 44c located in the through-holes 46 to connect together the outer seal portion 44a and the inner seal portion 44b in the radial direction. The inner seal portion 44b has a first seal portion 52 sealingly engageable with the valve seat portion 20 and a second seal portion 53 sealingly engageable with a distal end portion 54 of the male coupling member 3. The second seal portion 53 specifically has an abuttingly-sealingly engaging surface 53a extending radially outward from the first seal portion 52 perpendicularly to the longitudinal axis L so as to be abuttingly and sealingly engageable with a distal end surface 54a of the distal end portion 54 of the male coupling body 30, and an outer periphery sealingly engaging surface 53b extending forward from the abuttingly-sealingly engaging surface 53a in the direction of the longitudinal axis L so as to be sealingly engageable with an outer peripheral surface 54b of the distal end portion 54 of the male coupling body 30. The outer seal portion 44a is provided with a sliding projection 56 projecting radially outwardly and rearwardly. When the slide valve 18 is displaced between the close position and the open position, the sliding projection 56 slides while maintaining sealing contact with the inner surface 12 of the female coupling body 10. The first cylindrical portion 42a of the slide valve body 42 extends forward beyond the second seal portion 53 of the seal member 44, so that the inner peripheral surface 50 of the forward extension of the first cylindrical portion 42a is slidingly engageable with an outer peripheral surface 58 of the male coupling body 30.

When the pipe coupling 1 is in the uncoupled state shown in FIG. 1, the slide valve 18 of the female coupling member 2 is held in the close position by being urged by the spring 26. When the slide valve 18 is in the close position, the outer seal portion 44a of the seal member 44 sealingly engages the inner surface 12 of the female coupling body 10, and the first seal portion 52 of the inner seal portion 44b sealingly engages the valve seat portion 20, thereby closing the valve opening 22. Consequently, the fluid in the fluid passage 14 of the female coupling member 2 is prevented from leaking to the outside. At this time, a portion of the outer peripheral surface 48 of the slide valve body 42 which comprises the first cylindrical portion 42a supports, from the radially inner side, locking elements 62 disposed in locking element retaining holes 60 in the female coupling body 10.

As the male coupling member 3 is inserted into the female coupling member 2 from the position shown in FIG. 1, the outer peripheral surface 58 of the male coupling body 30 slides along the inner peripheral surface 50 of the slide valve 18 of the female coupling member 2, thereby being guided by the inner peripheral surface 50. When the male coupling member 3 is inserted to the position shown in FIG. 2, a distal end surface 66 of the slide valve 36 of the male coupling member 3 abuts against a distal end surface 64 of the fixed valve seat member 16 of the female coupling member 2, and the seal member 44 and the distal end portion 54 of the male coupling body 30 are sealingly engaged with each other. The sealing engagement between the seal member 44 and the distal end portion 54 of the male coupling body 30 is preferably made in such a manner that the distal end portion 54 of the male coupling body 30 abuts against the abuttingly-sealingly engaging surface 53a of the seal member 44. In the example shown in FIG. 2, the distal end surface 54a of the male coupling body 30 is not in abutment contact with the abuttingly-sealingly engaging surface 53a of the seal member 44, and a slight gap is left therebetween. In this regard, however, the outer periphery sealingly engaging surface 53b is engaged with the outer peripheral surface 58 of the male coupling body 30, thereby achieving the sealing engagement between the seal member 44 and the distal end portion 54 of the male coupling body 30. Further, at this time, the outer peripheral surface 58 of the male coupling body 30 is engaged and covered with a portion of the inner peripheral surface 50 of the slide valve 18 of the female coupling member 2 which comprises the first cylindrical portion 42a. Therefore, no substantial inclination will occur between the female coupling member 2 and the male coupling member 3 even if the female coupling member 2 and the male coupling member 3 are subjected to a force that would otherwise cause relative inclination therebetween. Accordingly, there will be almost no change in the relative positional relationship between the seal member 44 and the distal end portion 54 of the male coupling body 30, and the sealing therebetween will be maintained.

As the male coupling member 3 is further inserted into the female coupling member 2 from the position shown in FIG. 2, the distal end surface 54a of the male coupling body 30 abuts against the abuttingly-sealingly engaging surface 53a of the seal member 44 and presses the latter rearward, thereby bringing the slide valve 18 of the female coupling member 2 into the open position. In addition, the slide valve 36 of the male coupling member 3 is also pressed by the distal end surface 64 of the fixed valve seat member 16 and thus brought into the open position. At this time, the outer seal portion 44a of the seal member 44 slides along the inner surface 12 of the female coupling body 10 while maintaining sealing engagement. The sealing engagement between the seal member 44 and the male coupling body 30 is made at two positions: an area of contact between the abuttingly-sealingly engaging surface 53a and the distal end surface 54a; and an area of contact between the outer periphery sealingly engaging surface 53b and the outer peripheral surface 54b. Thus, the fluid passage 14 in the female coupling member 2 and the fluid passage 34 in the male coupling member 3 are sealingly connected to each other through the slide valve 18. Further, the locking elements 62 of the female coupling body 10 move radially inward to engage in an engagement groove 68 formed on the outer peripheral surface 58 of the male coupling body 30 and are pressed from the radially outer side by a sleeve 70 having been moved forward by the urging force of a spring 71. In this way, the female coupling member 2 and the male coupling member 3 are coupled and locked to each other.

The seal member 44 can be formed by injection-molding a rubber material onto the slide valve body 42. More specifically, the seal member 44 may be formed as follows. The slide valve body 42, which is made of a metal, e.g. stainless steel, is coated with an adhesive at the surface of a portion thereof where the seal member 44 is to be formed. Thereafter, the slide valve body 42 is set in a mold, and a rubber material is injection-molded to form the seal member 44. Thereafter, the seal member 44 is heated, together with the slide valve body 42, in an oven to bake and vulcanize-bond the seal member 44 to the slide valve body 42. Vulcanization bonding enables the seal member 44 to be bonded even more firmly to the slide valve body 42; therefore, it is possible to prevent the seal member 44 from coming off the slide valve body 42. It should be noted that a gate of the mold that is provided to inject a rubber material is preferably positioned at an inclined surface 72 rearward of the first seal portion 52. The inclined surface 72 does not engage any member; therefore, even if a gate mark is left on the inclined surface 72, no influence will be exerted on the sealing performance. In addition, the slide valve body 42 comprising the first, second and third cylindrical portions 42a, 42b and 42c, which are stepwisely reduced in diameter, can be formed by drawing a metal plate, as has been stated above. The slide valve 18 in this embodiment employs the seal member 44 having the above-described structure and uses the through-holes 46 and bonding to secure the seal member 44 and the slide valve body 42 to each other. Therefore, the slide valve 18 does not need to form by cutting or the like a groove for retaining the seal member 44 as required in the conventional slide valve body. Accordingly, the slide valve body 42 can have a simple configuration that can be produced by the above-described drawing process. The slide valve body 42 of the present invention that can be produced by drawing can be manufactured at a greatly reduced cost and very easily as compared with the conventional slide valve body 42 produced by cutting.

The main components of the female coupling member 2 are assembled by the following procedure. First, the slide valve 18 and the spring 26 are inserted into a cylindrical first body part 74 constituting a front end part of the female coupling body 10 from a rear opening 74a of the first body part 74. A front end edge 42d of the first cylindrical portion 42a of the slide valve body 42 is arrested by a stepped portion 74b (FIG. 1) formed on the inner peripheral surface of the first body part 74 at a position near the front end opening thereof. Next, the fixed valve seat member 16 is inserted from the rear opening 74a of the first body part 74. The inner diameter of the first seal portion 52 of the seal member 44 is smaller than the outer diameter of the valve seat portion 20 of the fixed valve seat member 16; therefore, insertion of the fixed valve seat member 16 causes an interference between the seal member 44 and the valve seat portion 20. However, because the seal member 44 is made of a rubber material of high elasticity, when the seal member 44 is pressed by the valve seat portion 20, the first seal portion 52 is deformed and enlarged in diameter, thereby allowing the valve seat portion 20 to pass through the first seal portion 52 to the front side. Thereafter, the fixed valve seat member 16 is retained by a lock ring 76, and a second body part 78 constituting a rear end part of the female coupling body 10 is secured to the first body part 74 by screwing.

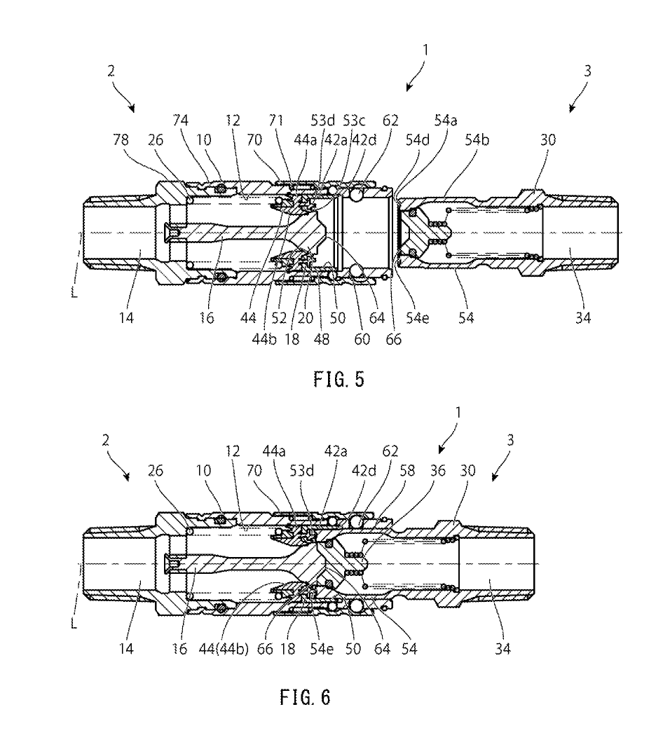

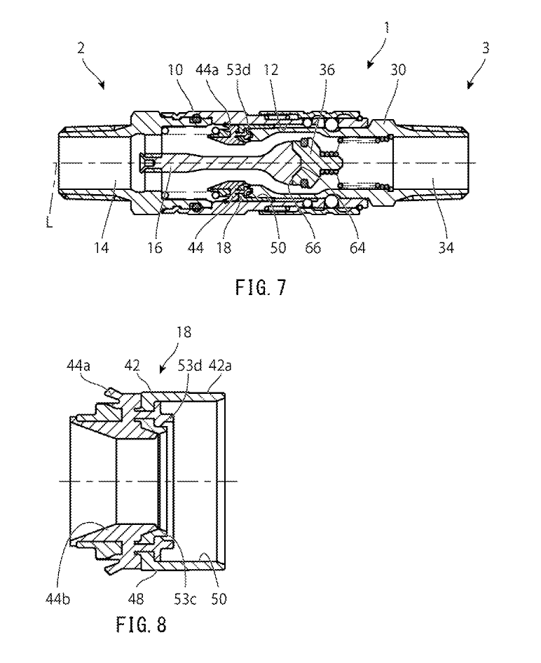

FIGS. 5 to 8 show a pipe coupling 1 according to a second embodiment. The pipe coupling 1 has the same basic structure as that of the pipe coupling 1 according to the above-described first embodiment; therefore, elements of the pipe coupling 1 according to the second embodiment that correspond to those of the above-described first embodiment are denoted by the same reference numerals as those used in the first embodiment and a detailed explanation thereof is omitted. In comparison to the first embodiment, the pipe coupling 1 of the second embodiment is characterized by having an annular abutting portion 53c and a thin-walled pliable annular portion 53d in place of the abuttingly-sealingly engaging surface 53a and outer periphery sealingly engaging surface 53b of the seal member 44 in the first embodiment. The annular abutting portion 53c is provided on the front end surface of the seal member 44 along the radially inner peripheral edge of the front end surface and configured to be engaged by the distal end surface 54a of the male coupling member 3. The thin-walled pliable annular portion 53d is provided radially outward of the abutting portion 53c to extend forward in the direction of the longitudinal axis L. The pliable annular portion 53d is configured such that when the distal end surface 54a of the male coupling member 3 abuts against the abutting portion 53c, the pliable annular portion 53d sealingly engages the distal end surface 54a of the male coupling member 3 and, while doing so, the pliable annular portion 53d is elastically deformed by being pressed by the distal end surface 54a. Thus, even if the female and male coupling members 2 and 3 coupled together as shown in FIG. 7 are subjected to an external force and slightly inclined relative to each other with respect to the longitudinal axis L, the pliable annular portion 53d is deformed in conformity with the inclination, thereby maintaining sealing between the inner seal portion of the seal member 44 and the distal end surface 54a of the male coupling member 3. In the illustrated embodiment, the distal end surface 54a of the male coupling member 3 is provided with a recess 54d corresponding to the pliable annular portion 53d. That is, the recess 54d is configured as follows. When the distal end surface 54a of the male coupling member 3 abuts against the abutting portion 53c as the male coupling member 3 is inserted into the female coupling member 2, an inclined surface 54e provided along the radially inner periphery of the recess 54d engages the pliable annular portion 53d, causing the pliable annular portion 53d to be slightly deflected radially outward, thereby enabling even more reliable sealing engagement between the pliable annular portion 53d and the distal end surface 54a of the male coupling member 3.

Although some embodiments of the present invention have been explained above, the present invention is not limited to the foregoing embodiments. For example, in the above-described embodiments, the seal member 44 has the first seal portion 52, which sealingly engages the valve seat portion 20, the second seal portion 53, which sealingly engages the distal end surface 54a of the male coupling member 3, and the sliding projection 56, which sealingly engages the inner surface 12 of the female coupling body 10. However, the seal member 44 need not necessarily have the second seal portion 53. That is, the arrangement may be such that the male coupling member 3 as inserted into the female coupling member 2 directly engages the slide valve body 42 to press the slide valve 18 rearward. Further, although in the second embodiment the inclined surface 54e is provided radially inside of the recess 54d to deflect the pliable annular portion 53d radially outward, the inclined surface 54e may be provided radially outside of the recess 54d to deflect the pliable annular portion 53d radially inward so that the recess 54d receives the deflected annular portion 53d. Alternatively, the recess 54d may be omitted. That is, the recess 54d is not needed, provided that when the female coupling member 2 and the male coupling member 3 are coupled to each other, the pliable annular portion 53d engages the distal end surface 54a of the male coupling member 3 to seal between itself and the distal end surface 54a, and that when the female coupling member 2 and the male coupling member 3 are inclined relative to each other with respect to the longitudinal axis L, the pliable annular portion 53d, which is thin-walled, is deformed in conformity with the inclination to maintain the sealing engagement between the pliable annular portion 53d and the distal end surface 54a of the male coupling member 3.

### LIST OF REFERENCE SIGNS

Pipe coupling 1; female coupling member 2; male coupling member 3; female coupling body 10; inner surface 12; fluid passage 14; fixed valve seat member 16; slide valve 18; valve seat portion 20; valve opening 22; base part 24; spring 26; male coupling body 30; inner surface 32; fluid passage 34; slide valve 36; spring 38; O-ring 40; slide valve body 42; first cylindrical portion 42a; second cylindrical portion 42b; third cylindrical portion 42c; front end edge 42d; seal member 44; outer seal portion 44a; inner seal portion 44b; connecting portion 44c; through-holes 46; outer peripheral surface 48; inner peripheral surface 50; first seal portion 52; second seal portion 53; abuttingly-sealingly engaging surface 53a; outer periphery sealingly engaging surface 53b; abutting portion 53c; pliable annular portion 53d; distal end portion 54; distal end surface 54a; outer peripheral surface 54b; recess 54d; inclined surface 54e; sliding projection 56; outer peripheral surface 58 (of male coupling member); locking element retaining holes 60; locking elements 62; distal end surface 64 (of fixed valve seat member); distal end surface 66 (of slide valve 36); engagement groove 68; sleeve 70; spring 71; inclined surface 72; first body part 74; rear opening 74a; stepped portion 74b; lock ring 76; second body part 78; longitudinal axis L.

1. A slide valve to be set in a fluid passage and displaceable in a direction of a longitudinal axis of the fluid passage to open or close the fluid passage, the slide valve comprising:
a cylindrical slide valve body to be set coaxially with the fluid passage, the slide valve body having an outer peripheral surface, an inner peripheral surface, and at least one through-hole extending through from the outer peripheral surface to the inner peripheral surface; and
a seal member having an annular outer seal portion located over the outer peripheral surface of the slide valve body, an annular inner seal portion located over the inner peripheral surface of the slide valve body, and a connecting portion located in the through-hole to connect together the outer seal portion and the inner seal portion.

2. The slide valve of claim 1, which is configured to be disposed in the fluid passage of a female coupling member having a female coupling body having an inner surface defining the fluid passage, the female coupling member further having a valve seat part provided in the fluid passage at a position spaced radially inward from the inner surface of the female coupling body to define an annular valve opening between the valve seat part and the inner surface, the slide valve being displaceable between a close position where the slide valve closes the valve opening and an open position where the slide valve opens the valve opening at a position rearward of the close position in the direction of the longitudinal axis;
wherein when the slide valve is in the close position, the inner seal portion of the seal member sealingly engages the valve seat part.

3. The slide valve of claim 1, which is configured to be disposed in the fluid passage of a female coupling member having a female coupling body having an inner surface defining the fluid passage, the female coupling member further having a valve seat part provided in the fluid passage at a position spaced radially inward from the inner surface of the female coupling body to define an annular valve opening between the valve seat part and the inner surface, the slide valve being displaceable between a close position where the slide valve closes the valve opening and an open position where the slide valve opens the valve opening at a position rearward of the close position in the direction of the longitudinal axis;
wherein the inner seal portion sealingly engages a distal end portion of a male coupling member as inserted into the female coupling member.

4. The slide valve of claim 1, which is configured to be disposed in the fluid passage of a female coupling member having a female coupling body having an inner surface defining the fluid passage, the female coupling member further having a valve seat part provided in the fluid passage at a position spaced radially inward from the inner surface of the female coupling body to define an annular valve opening between the valve seat part and the inner surface, the slide valve being displaceable between a close position where the slide valve closes the valve opening and an open position where the slide valve opens the valve opening at a position rearward of the close position in the direction of the longitudinal axis;
wherein when the slide valve is in the close position, the outer seal portion of the seal member sealingly engages the inner surface of the female coupling body, and the inner seal portion sealingly engages the valve seat part; and
wherein when the male coupling member is inserted into the female coupling member and the slide valve is brought into the open position, the outer seal portion of the seal member sealingly engages the inner surface of the female coupling body, and the inner seal portion sealingly engages a distal end portion of the male coupling member.

5. The slide valve of claim 2, wherein when the slide valve is displaced between the close position and the open position, the outer seal portion slides along the inner surface of the female coupling body.

6. The slide valve of claim 2, wherein the inner seal portion has an abuttingly-sealingly engaging surface abuttingly and sealingly engageable with a distal end surface of the distal end portion of the male coupling member, and an outer periphery sealingly engaging surface extending forward from the abuttingly-sealingly engaging surface to sealingly en

7. The slide valve of claim 2, wherein the slide valve body has a first cylindrical portion sliding along the inner surface of the female coupling member, the first cylindrical portion having an inner peripheral surface which is slidingly engaged with the male coupling member as inserted into the female coupling member, the slide valve body further having a second cylindrical portion contiguous with the first cylindrical portion and smaller in diameter than the first cylindrical portion;
the through-hole being formed in the second cylindrical portion; and
the outer seal portion being located over an outer peripheral surface of the second cylindrical portion.

8. The slide valve of claim 1, wherein the slide valve body is made of a circular cylindrical member with a substantially uniform wall thickness.

9. The slide valve of claim 2, wherein the slide valve body further has an abutment portion which is abutted by the distal end portion of the male coupling member as inserted into the female coupling member;
the inner seal portion having a pliable annular portion extending forward in the direction of the longitudinal axis beyond the abutment portion and centered at the longitudinal axis, so that when the distal end portion of the male coupling member abuts against the abutment portion, the pliable annular portion is pressed and elastically deformed by the distal end surface of the male coupling member while sealingly engaging the distal end surface.

10. The slide valve of claim 1, wherein the slide valve body is made of a metal plate, and the seal member is made of rubber, the seal member made of rubber being vulcanized and bonded to the slide valve body at a portion thereof contacting the slide valve body.

11. A female coupling member having the slide valve of claim 1.

12. A pipe coupling comprising the female coupling member of claim 11, and a male coupling member configured to be coupled to the female coupling member by being inserted into the fluid passage in the female coupling member.

13. The slide valve of claim 3, wherein when the slide valve is displaced between the close position and the open position, the outer seal portion slides along the inner surface of the female coupling body.

14. The slide valve of claim 4, wherein when the slide valve is displaced between the close position and the open position, the outer seal portion slides along the inner surface of the female coupling body.

15. The slide valve of claim 3, wherein the inner seal portion has an abuttingly-sealingly engaging surface abuttingly and sealingly engageable with a distal end surface of the distal end portion of the male coupling member, and an outer periphery sealingly engaging surface extending forward from the abuttingly-sealingly engaging surface to sealingly engage an outer peripheral surface of the distal end portion of the male coupling member.

16. The slide valve of claim 4, wherein the inner seal portion has an abuttingly-sealingly engaging surface abuttingly and sealingly engageable with a distal end surface of the distal end portion of the male coupling member, and an outer periphery sealingly engaging surface extending forward from the abuttingly-sealingly engaging surface to sealingly engage an outer peripheral surface of the distal end portion of the male coupling member.

17. The slide valve of claim 3, wherein the slide valve body has a first cylindrical portion sliding along the inner surface of the female coupling member, the first cylindrical portion having an inner peripheral surface which is slidingly engaged with the male coupling member as inserted into the female coupling member, the slide valve body further having a second cylindrical portion contiguous with the first cylindrical portion and smaller in diameter than the first cylindrical portion;
the through-hole being formed in the second cylindrical portion; and
the outer seal portion being located over an outer peripheral surface of the second cylindrical portion.

18. The slide valve of claim 4, wherein the slide valve body has a first cylindrical portion sliding along the inner surface of the female coupling member, the first cylindrical portion having an inner peripheral surface which is slidingly engaged with the male coupling member as inserted into the female coupling member, the slide valve body further having a second cylindrical portion contiguous with the first cylindrical portion and smaller in diameter than the first cylindrical portion;
the through-hole being formed in the second cylindrical portion; and
the outer seal portion being located over an outer peripheral surface of the second cylindrical portion.

19. The slide valve of claim 3, wherein the slide valve body further has an abutment portion which is abutted by the distal end portion of the male coupling member as inserted into the female coupling member;
the inner seal portion having a pliable annular portion extending forward in the direction of the longitudinal axis beyond the abutment portion and centered at the longitudinal axis, so that when the distal end portion of the male coupling member abuts against the abutment portion, the pliable annular portion is pressed and elastically deformed by the distal end surface of the male coupling member while sealingly engaging the distal end surface.

20. The slide valve of claim 4, wherein the slide valve body further has an abutment portion which is abutted by the distal end portion of the male coupling member as inserted into the female coupling member;
the inner seal portion having a pliable annular portion extending forward in the direction of the longitudinal axis beyond the abutment portion and centered at the longitudinal axis, so that when the distal end portion of the male coupling member abuts against the abutment portion, the pliable annular portion is pressed and elastically deformed by the distal end surface of the male coupling member while sealingly engaging the distal end surface.
